(19) United States
(12) Patent Application Publication
(10) Pub. No.: US 2015/0228045 A1
(43) Pub. Date: Aug. 13, 2015

(54) METHODS FOR EMBEDDING AND EXTRACTING A WATERMARK IN A TEXT DOCUMENT AND DEVICES THEREOF

(71) Applicant: Infosys Limited, Bangalore (IN)

(72) Inventors: Sachin Mehta, Kangra (IN); Rajarathnam Nallusamy, Trichy District (IN)

(21) Appl. No.: 14/493,782

(22) Filed: Sep. 23, 2014

(30) Foreign Application Priority Data
Sep. 23, 2013 (IN) 4299/CHE/2013

(51) Int. Cl. G06T 1/00; G06T 3/40; G06T 7/00; H04N 1/32

(52) U.S. Cl. CPC G06T 1/0064; H04N 1/32352; H04N 1/3232; G06T 3/4007; G06T 7/0095; G06T 2201/0065; G06T 2201/0062; G06T 2201/0061; H04N 2201/3236; G06T 2207/20221; G06T 2210/22

(57) ABSTRACT

Method, apparatus and non-transitory computer readable medium for embedding and extracting a watermark in a text document using digital watermarking processes is disclosed. When the text document is watermarked, the following steps are performed. The pages of the text document are transformed into corresponding images. Then, the margins on each of the images are detected and cropped to generate the cropped images. The cropped images are segmented into blocks among which some blocks are selected based on content of each block. The watermark is embedded in the selected blocks using a digital watermarking process. When the watermark from the watermarked text document is extracted, the watermark-embedding process is referred to determine the block information, for selecting each block of a watermarked text document, from where the watermark needs to be extracted.

This application claims the benefit of Indian Patent Application Filing No. 4299/CHE/2013, filed Sep. 23, 2013, which is hereby incorporated by reference in its entirety.

### FIELD

This technology generally relates to the field of watermarking technology and more particularly to a technique for embedding and extracting a watermark in a text document.

### BACKGROUND

The advancement in technology especially innovations related to information dissemination and connectivity has led to the development of portable and web enabled devices. However, these advancements have increased the Intellectual Property Rights (IPR) violations. To distribute the digital document securely and protect the text document from IPR violations, watermarking of text documents is gaining interest. Watermarking has emerged as an eminent solution for the protection of digital media (text documents, videos, audio, and images). However, watermarking in text documents is very different than other digital media since text documents lack rich gray scale or color texture information which is abundantly available in digital images and videos.

Generally, text watermarking methods used are Character Feature method, Open Space method, Zero Watermarking method, Content Watermarking method, Syntax Watermarking method, and the like. In Character Feature method, features of characters such as shape, size, or position are manipulated. In Open space method the watermark is embedded by modulating either the inter-line distance or inter-word space or inter-character space. In Zero Watermarking method, instead of embedding a watermark inside the text document, watermark is generated using the features of the text document. In Content Watermarking method, words are replaced by their synonyms or sentences are transformed via suppression or inclusion of noun phrases. In Syntax Watermarking method, marking is achieved by changing the structure of the sentences. There are other watermarking methods wherein the watermark is embedded visually as an image. Majority of these methods carry very less amount of information which limits their applicability to document authentication, copyright protection, and tamper proofing. Additionally, some of these methods utilize the specific characteristics of a particular language which makes their application into other language documents very difficult. Thirdly, syntax and semantic methods are based on substitution. Sometimes substitution may change the meaning of the sentence. Hence, every watermarked document needs to be manually inspected. This is a tedious process and makes the method practically infeasible.

Watermarking of text documents is a less matured area in comparison to digital images and videos. Significant amount of work has been done for digital images and videos ranging from copyright protection to traitor tracing. Since text documents lacks rich gray scale or color texture information, watermarking in text documents is very different than other digital media.

Though techniques might exist to cater the problem of watermarking the text document, the existing techniques do not leverages application of digital image and video watermarking methods in a text documents.

Therefore, there is a general need to implement a technique which utilizes any digital image or video watermarking method to watermark text documents.

### SUMMARY

Accordingly, the present disclosure is directed to a system, a non-transitory computer readable medium and a method for embedding a watermark in a text document, comprising receiving a watermark and the text document containing one or more pages and transforming the pages of the text document into corresponding images. The margins on each image are detected and cropped to generate cropped image. The cropped image is segmented into plurality of blocks. One or more blocks are selected from the plurality of blocks using selection protocols and the watermark is embedded in each of the selected block. The watermark embedded blocks are superimposed onto the corresponding blocks of one or more images and these images are converted into pages of the text document with watermark embedded.

In one embodiment, the margins are detected by applying the discrete differentiation operator over the images and computing a distance of a first white pixel from the sides of the images. Further, the cropped images are generated by cropping the one or more images from the sides based on the computed distance of the first white pixel from the sides of the images. In another embodiment, one or more blocks are selected from the plurality of blocks by applying a discrete cosine transform (DCT) on each of the plurality of blocks to compute a DCT co-efficient of the block and classifying the plurality of blocks into texture blocks or non-texture blocks using the DCT co-efficient. The blocks are classified by comparing the DCT co-efficient of each of the one or more block with content thresholds. In yet another embodiment, the watermarking process is either an image or a video watermarking process.

Further, another example of this technology is directed to a system, a computer program product and a method for extracting a watermark from a watermarked text document, comprising receiving the watermarked text document comprising of one or more pages and block information, wherein the block information comprises segmentation process details such as block size, an original cropped image size, and content thresholds. The pages are converted into the corresponding images. The margins on each image are detected and cropped to generate cropped image. The cropped images are resized based on the received original cropped image size. Then, the cropped image is segmented into plurality of blocks based on the segmentation process details. One or more blocks are selected from the plurality of blocks based on the content thresholds and the watermark is extracted from the selected blocks. In one embodiment, resizing of the one or more cropped images is based on an interpolation process. However, other resizing methods can be used.

Further, in another example of this technology, the margins are detected by applying the discrete differentiation operator over the images and computing a distance of a first white pixel from the sides of the images. Further, the cropped images are generated by cropping the one or more images from the sides based on the computed distance of the first white pixel from the sides of the image. In another embodiment, one or more blocks are selected from the plurality of blocks by applying a Discrete Cosine Transform (DCT) on each of the plurality of blocks to compute a DCT co-efficient of the block and classifying the plurality of blocks into texture blocks or non-texture blocks using the DCT co-efficient. The blocks are classified by comparing the DCT co-efficient of each of the one or more blocks with content thresholds. In yet another embodiment, the watermarking process is either an image or a video watermarking process.

### BRIEF DESCRIPTION OF THE DRAWINGS

FIG. 1 is a flow chart of an example of a method for embedding a watermark in a text document.

FIG. 2 is a diagram of an example of a manner of generating a cropped image.

FIG. 3 is a diagram with examples of blocks of the cropped page image.

FIG. 4 is a flow chart of an example of a method for extracting a watermark from a watermarked text document.

FIG. 5 is a block diagram of an example of a watermark embedding computing device configured to be capable of embedding a watermark in a text document.

FIG. 6 is a block diagram of another example of a watermark extracting computing device configured to be capable of extracting a watermark from a watermarked text document.

FIG. 7 shows an exemplary watermark management computing device, such as watermark embedding computing device and/or watermark extracting computing device, useful for performing processes disclosed herein.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings. While the invention described herein is provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof.

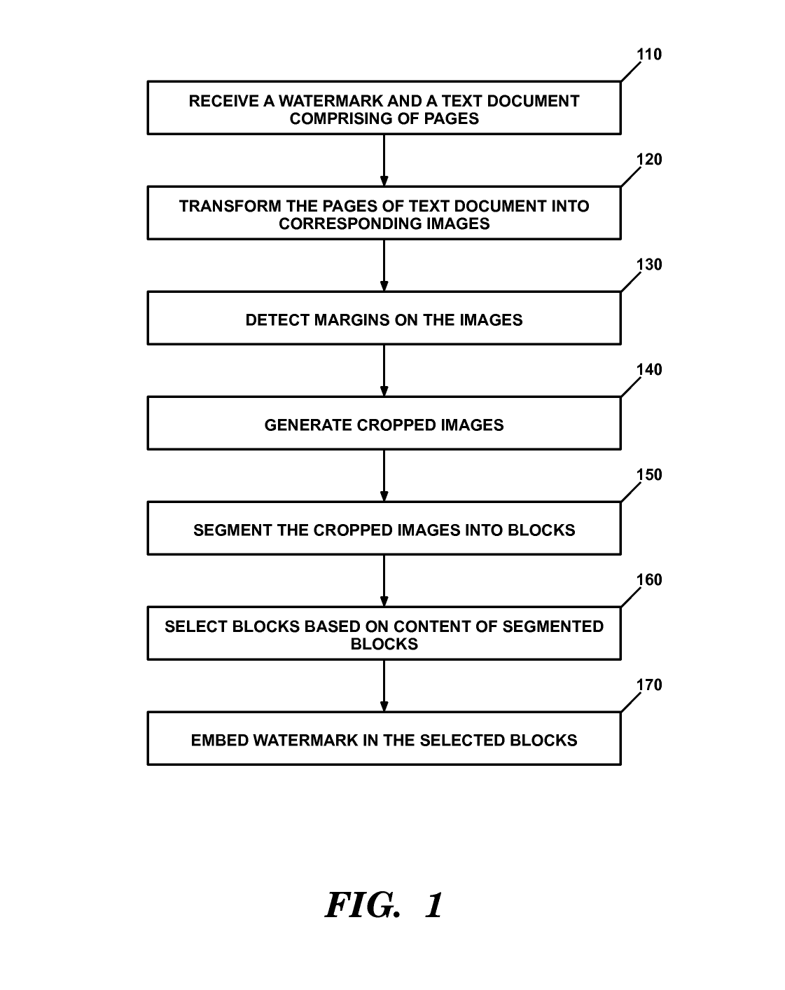

FIG. 1 is an example of a method for embedding a watermark in a text document. As used herein, a “text document” refers to any structured or unstructured document which comprises text or graphics or the combination thereof. The text document could be in any file format such as word, PDF, Excel, PPT, CHM, TXT and the like. The text document comprises one or more pages. At step 110, the text document on which watermark need to be embedded is received by a watermark embedding computing device. The text document could be selected by a user. Further, the watermark embedding computing device receives the watermark which needs to be embedded on the pages of the document. For the purpose of illustration, let us say that text document has P pages of dimension N×M and watermark of dimension n×m. The watermark can be either static (for applications such as copyright protection) or dynamic (for applications such as traitor tracing). Dynamic watermark is generated on-the-fly.

At step 120, the pages of the text document are transformed into image format such as TIFF, GIF, JPEG, and the like. For the purpose of illustration, the text document is converted into images/such that each page represents one image and dimension of each page is N×M. As appreciated by a person skilled in the art, the conversion of the text document into image format can be performed using any known technique or tool.

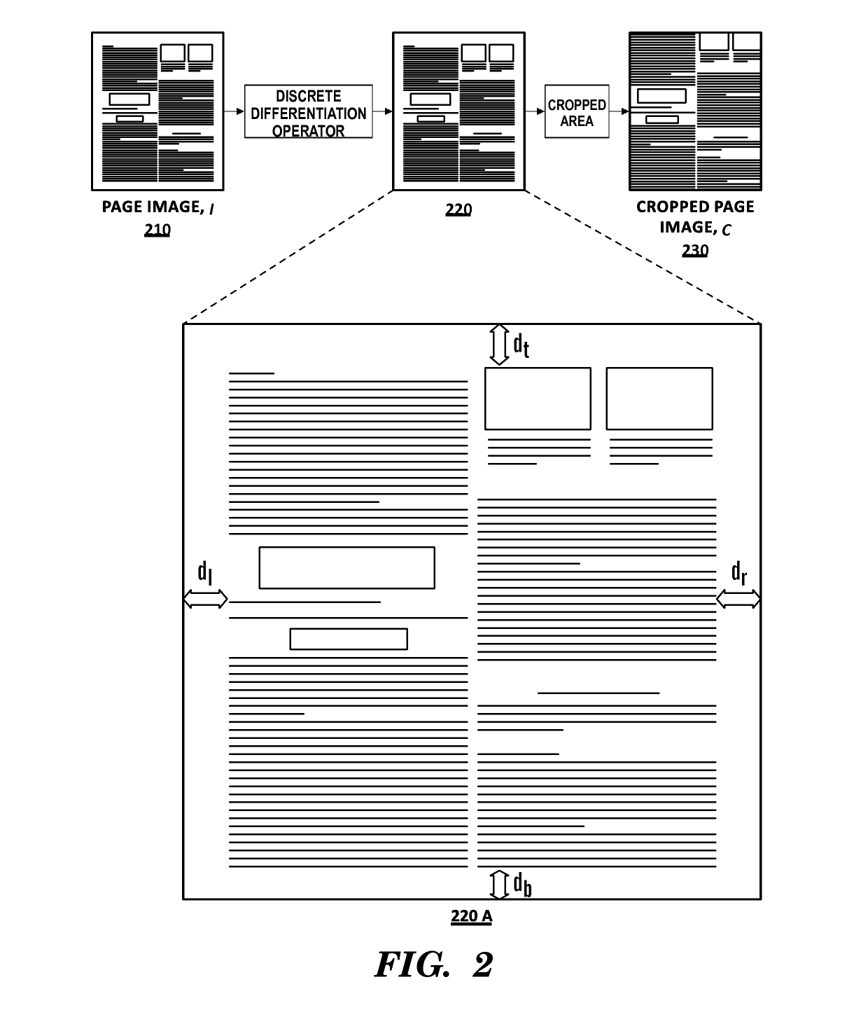

Typically, pages of text document contain margins. As used herein “margins” refers to blank space at the top, bottom, and sides of the page that frames the body of written, typed, or printed matter (which include text or graphics or the combination thereof). At step 130, the margins of each page of the text document are detected. As shown in FIG. 2, document 220a shows margins dₗ, dₜ, dᵣ, and d_{b} for left, top, right, and bottom side of the page respectively. At step 140, the detected margins are cropped to generate cropped image C of each page of the text document. The method of cropping the margins from the image is explained in detail in FIG. 2.

At step 150, the cropped image C is segmented into different blocks. Let's say the cropped image C is divided into b blocks of dimension b₁×b₂. At step 160, one or more blocks are selected from b blocks. For selecting the blocks, a discrete cosine transform (DCT) is applied on each of the blocks to compute a DCT co-efficient of each block. Let us represent the transformed block as b_{dct}. Then, at step 160, the blocks are classified into texture blocks or non-texture blocks based on the value of DCT co-efficient of each block as explained below.

A block is considered as a non-texture block if:

b_{dct}(0, 0)>T₁, wherein b_{dct} represent the transformed block after applying DCT on a block.

Texture block can be either completely text or completely graphics or partial text or partial graphics and partial text. Texture blocks are classified as:

$${b}_{txt} = \{ \begin{matrix}Partial text , & if {T}_{2} < {b}_{dct} ( 0 , 0 ) \leq {T}_{1} \\ Complete text , & if {T}_{3} < {b}_{dct} ( 0 , 0 ) \leq {T}_{2} \\ Partial Text and Graphics , & if {T}_{4} < {b}_{dct} ( 0 , 0 ) \leq {T}_{3} \\ Complete Graphics & if {T}_{5} < {b}_{dct} ( 0 , 0 ) \leq {T}_{4}\end{matrix}$$

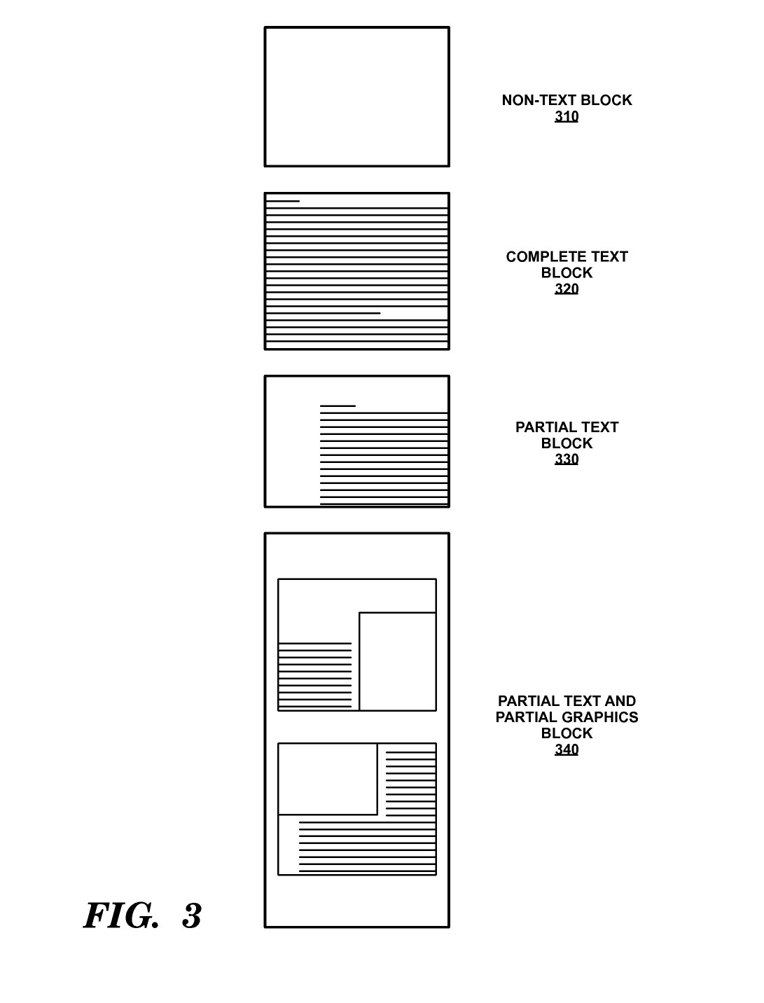

T₁, T₂, T₃, T₄, and T₅ are the content thresholds used to classify the blocks. The DCT co-efficient of each block is compared with content thresholds. Different types of block based on the content are illustrated and explained with respect to FIG. 3. bₜₓₜ herein represents the blocks that are classified as texture blocks. The content thresholds may be decided by a user (fixed) or could be automatically calculated by a system (adaptive).

At step 170, the watermark is embedded in the selected texture blocks. The watermark can be embedded using any image or video watermarking algorithm in blocks which are classified as texture blocks. The reason of embedding the watermark in texture block is due to imperceptibility of the watermark. Embedding the watermark in non-texture blocks has chances of being either perceptible or lost. For instance, completely white block, a non-texture block, has pixels having value 255. If we add watermark to such non-texture block using an image or video watermarking algorithm, the value of the pixels in that block will increase i.e. >255. Since pixels in a block can have a value between 0 and 255, the value will be truncated to 255 leading to automatic removal of watermark. The watermarked texture blocks are superimposed onto the corresponding blocks of the image to get watermarked image and then, watermarked image is converted back into the text document to get watermarked text document.

FIG. 2 illustrates an embodiment depicting the manner of generating a cropped image. The cropped page image 230 is generated by detecting the margins on the page image and then cropping the margins. For the purpose of illustration, let us say the page image 210 is of dimension N×M. To detect the margins on the page image 210, a discrete differentiation operator such as SOBEL or SCHARR and the like is applied. The differentiator operator finds the high intensity variations in the text image such as text area (including images, equations, etc.) The output of the discrete differentiation operator is image 220 in FIG. 2. Now from each sides of the image 220, the first white pixel is identified to determine the margins on the image 220. Let us represent the distance of first white pixel from the top, bottom, left, and right as dₜ, d_{b}, dₗ, and dᵣ, respectively as shown in 220a (which shows the expansion of 220). After the margin distances are determined, the text area from page image I 210 is cropped to generate cropped page image C 230.

FIG. 3 illustrates exemplary blocks of the cropped page image. The cropped page image is segmented into b blocks of dimension b₁×b₂. Among these b blocks, one or more blocks are selected using selection protocols for embedding the watermark on the selected blocks. For selecting the blocks, a discrete cosine transform (DCT) is applied on each of the blocks to compute a DCT co-efficient of each block. Let us represent the transformed block as b_{dct}. Now, b_{dct} value is compared with different content thresholds to classify if the block is a texture block or a non-texture block. 310 in FIG. 3 indicate a block with minimal text. This block may be classified as a non-texture block. 320 represent a complete texture block. 330 shows a block with partial text and partial empty space. 340 represent two blocks wherein the blocks contain partial text and partial graphics. The classification of blocks 310, 320, 330, and 340 as texture block or a non-texture block is dependent on different content thresholds.

A block is considered a non-texture block if:

b_{dct}(0,0)>T₁, wherein b_{dct} represent the transformed block after applying DCT on a block.

Texture block can be either completely text or completely graphics or partial text or partial graphics and partial text. Texture blocks are classified as:

$${b}_{txt} = \{ \begin{matrix}Partial text , & if {T}_{2} < {b}_{dct} ( 0 , 0 ) \leq {T}_{1} \\ Complete text , & if {T}_{3} < {b}_{dct} ( 0 , 0 ) \leq {T}_{2} \\ Partial Text and Graphics , & if {T}_{4} < {b}_{dct} ( 0 , 0 ) \leq {T}_{3} \\ Complete Graphics & if {T}_{5} < {b}_{dct} ( 0 , 0 ) \leq {T}_{4}\end{matrix}$$

The threshold value of T₁, T₂, T₃, T₄, and T₅ may be predefined and provided manually or can be adaptive and computed automatically. Based on the above classification, blocks with partial text 330, complete text 320, partial text and partial graphics 340, and complete graphics may be classified as texture blocks and block with minimal or no text 310 may be classified as non-texture block. As appreciated by an ordinary person skilled in the art, the classification of blocks as texture block and non-texture may differ with content thresholds. In one embodiment, the partial text block 330 may be classified as non-texture block.

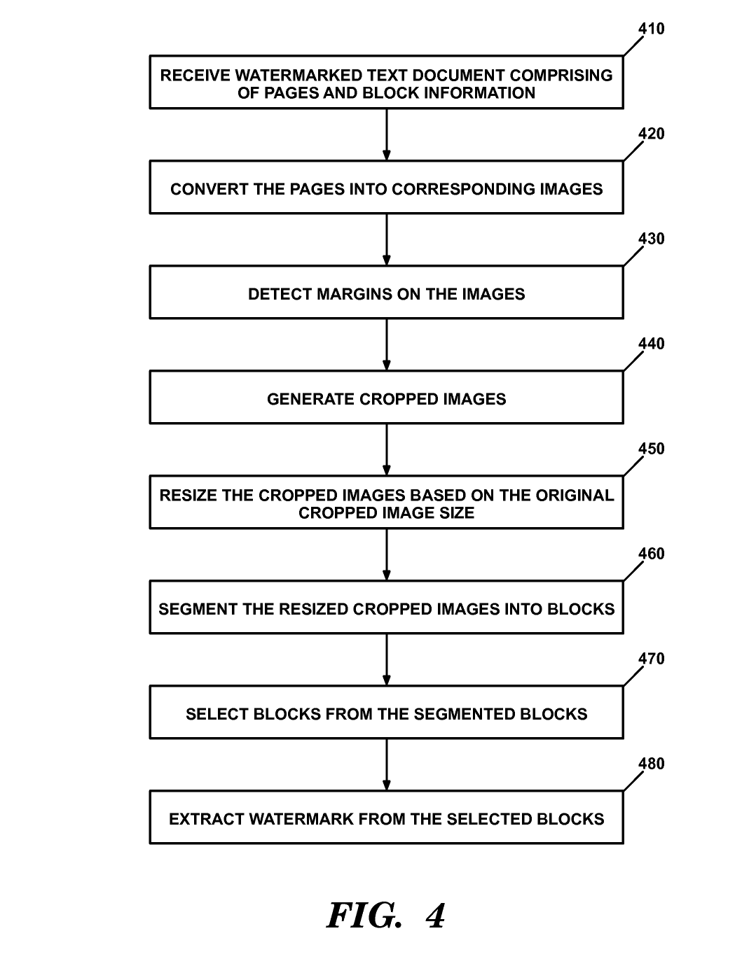

FIG. 4 is an example of a method for extracting a watermark from a watermarked text document. At step 410, watermark extraction computing device receives a watermarked text document and the block information. The watermarked text document comprises one or more pages embedded with a watermark. Let us say that document has P′ pages of dimension N′×M′. The block information comprises, but not limited to, segmentation process details like block size, original cropped image size, and a content thresholds. The block information may be retrieved from the watermark embedding process wherein the watermark is embedded using the process as explained in FIG. 1. At step 420, the pages of the text document are converted into the corresponding images. Convert the document into page images I′ such that each page represents one image and dimension of each page is N′×M′.

At step 430, the margins on the images are detected by applying discrete differentiation operator as explained in detail in FIG. 2. At step 440, cropped images are generated by cropping the detected one or more margins from each of the images as explained in FIG. 2. Let us say that cropped text area is C′ having dimension N′_{C}×M′_{C} such that N′_{c}≦N′ and M′_{c}≦M′. The cropping is achieved by applying the same discrete differentiation operator as used in the watermark embedding process. Let us denote the output of the discrete differentiation operator as I′_{d}. The first white pixel is computed from the top, bottom, left, and right and can be represented as d′_{c}, d′_{b}, d′ₗ, and d′ᵣ respectively. After obtaining the margin distances, crop the text area from I′ to obtain C′.

At step 450, the cropped images are resized based on the received original cropped image size. Since the dimensions of cropped page image C′ (during watermark extraction process) and cropped page image C (during watermark embedding process) might be different which may affect the position of blocks and hence, C′ is resized to C. Resizing of the cropped images may be based on the interpolation process or any other known resizing method.

At step 460, the cropped page image C′ is segmented in b′ block of dimension b₁×b₂ based on the received segmentation process details. At step 470, the blocks are selected from b′ blocks based on the received content thresholds using the same approach as used in watermark embedding process, explained in FIG. 1 and FIG. 3. At step 470, after the blocks are selected, the watermark is extracted from the selected blocks based on the same image or video watermarking algorithm which is used in watermark embedding process.

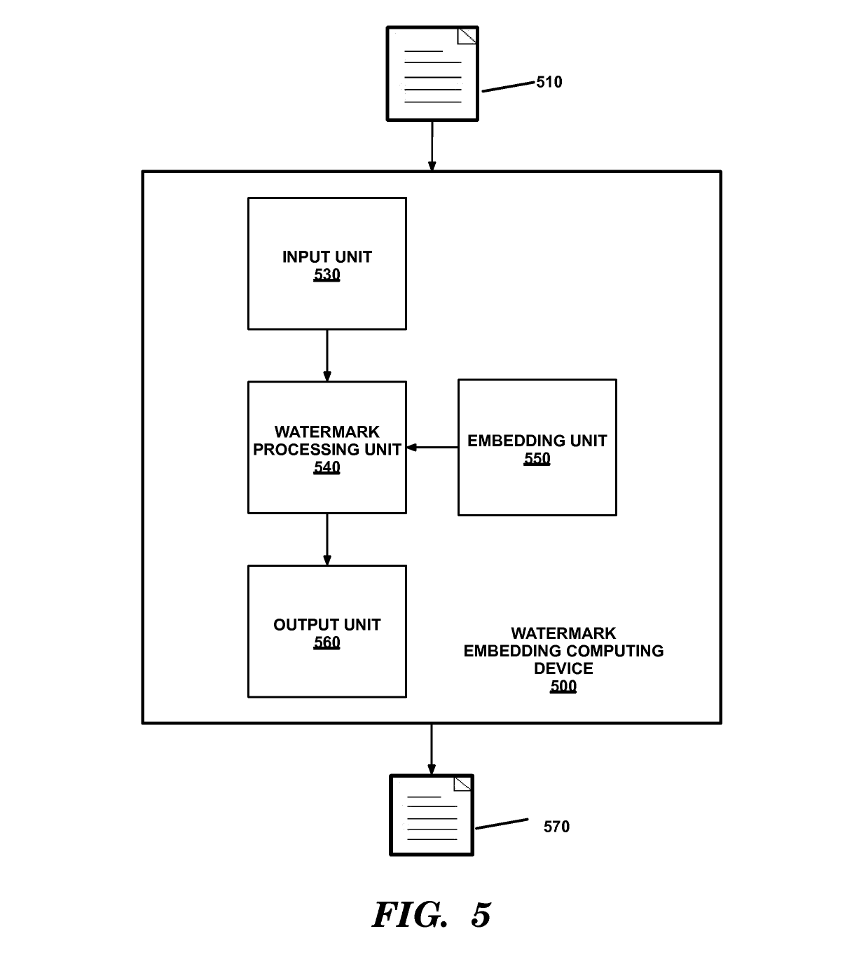

FIG. 5 is a block diagram of an example of a watermark embedding computing device 500 configured to be capable of embedding a watermark in a text document. Watermark embedding computing device 500 comprises input unit 530, watermark processing unit 540, embedding unit 550 and output unit 560. Watermark embedding computing device 500 receives using the input unit 530 the text document 510 comprising of one or more pages on which watermark need to be embedded. The input unit 530 further receives the watermark which needs to be embedded on the pages of the text document 510.

Watermark processing unit 540 transform the pages of the text document into image format such as TIFF, GIF, JPEG, and the like. Further the watermark processing unit 540, detects the margins in each transformed page image and crop the margins to generate the cropped page image C. The method of cropping the margins from the image is explained in detail in FIG. 2. The cropped image C is segmented into different blocks. Among the selected blocks, one or more blocks are classified as a texture block or a non-texture block based on the method as explained in FIG. 1 and FIG. 3. Embedding unit 550 embeds the watermark using a known image or video watermarking algorithm in blocks which are classified as texture blocks.

Watermark processing unit 540, further superimposes the watermarked texture blocks onto the corresponding blocks in images to obtain watermarked images and the watermarked images are then converted back into the text document to obtain watermarked text document. The watermarked text document embedded with the watermark is provided as output by output unit 560.

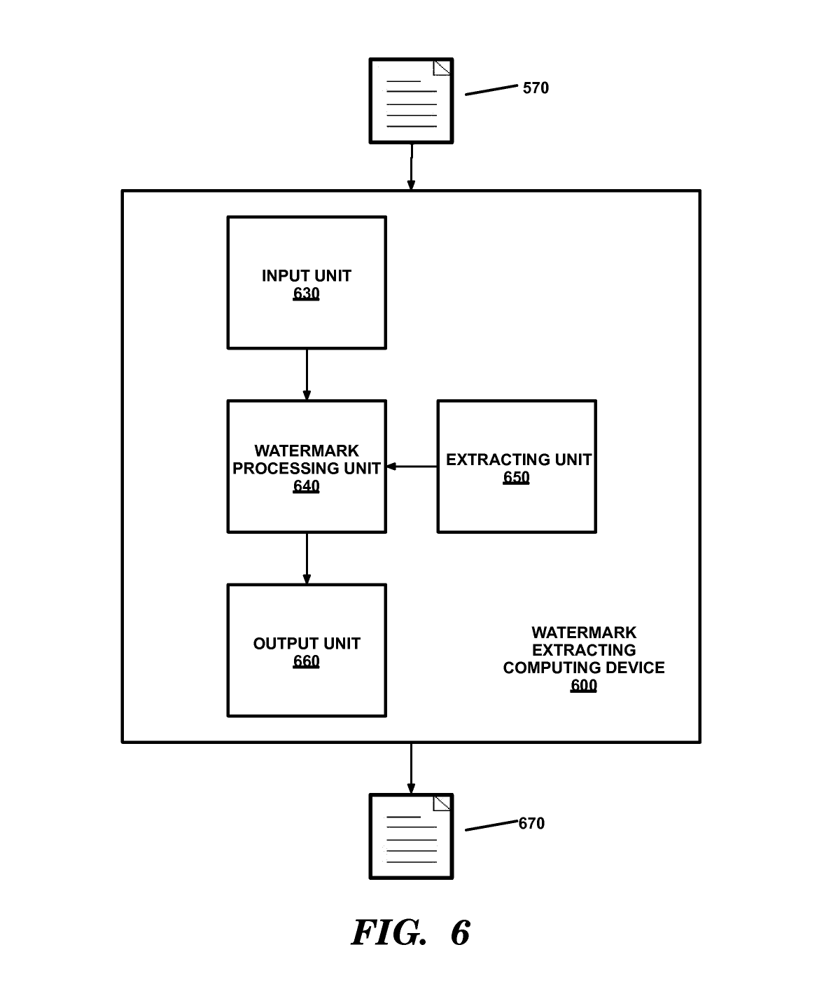

FIG. 6 is a block diagram of an example of a watermark extracting computing device 600 configured to be capable of extracting a watermark from a watermarked text document. Watermark extracting computing device 600 comprises input unit 630, watermark processing unit 640, extracting unit 650 and output unit 660. Watermark extracting computing device 600 receives using the input unit 630 the watermarked text document 570 comprising of one or more pages with embedded watermark. The input unit 630 further receives block information. The block information comprises, but not limited to, segmentation process details like block size, original cropped image size and content thresholds. The block information may be retrieved from the watermark embedding process wherein the watermark is embedded using the process as explained in FIG. 1.

Watermark processing unit 640 converts the pages of the text document into the corresponding images. The watermark processing units 640 detects the margins in each transformed page image by applying discrete differentiation operator and crops the margins to generate the cropped page image as explained in detail in FIG. 2. Watermark processing unit 640 resizes the cropped images based on the received original cropped image size. Resizing of the cropped images may be based on an interpolation process or other known techniques. Further, the watermark processing unit 640 segments the cropped page image into blocks of dimension b₁×b₂ based on the received segmentation process details. Among the segmented blocks, watermark processing unit 640 select blocks based on the received content thresholds using the same approach as used in watermark embedding process, as explained in FIG. 1 and FIG. 3.

Extracting unit 650 extracts the watermark from the selected blocks based on the same image or video watermarking algorithm which is used in watermark embedding process as explained in FIG. 1. Output unit 660 provides the extracted watermark 670.

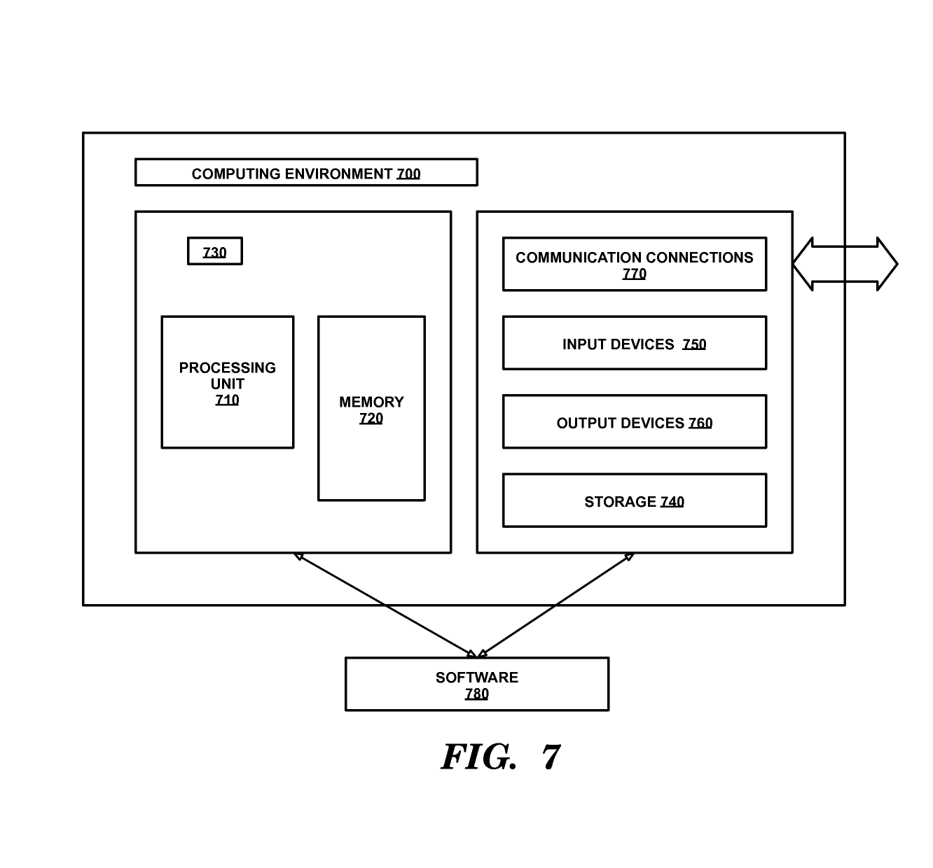

One or more of the above-described techniques may be implemented in or involve one or more computer systems. FIG. 7 illustrates an example of a watermark management computing device 700 which may comprise watermark embedding computing device 500 and/or watermark extracting computing device 600, although watermark management computing device 700 may comprises other types and/or numbers of computing devices configured to be capable of implementing this technology. The watermark management computing device 700 is not intended to suggest any limitation as to scope of use or functionality of described embodiments.

With reference to FIG. 7, the watermark management computing device 700 includes at least one processing unit 710 and memory 720. In FIG. 7, this most basic configuration 730 is included within a dashed line. The processing unit 710 executes non-transitory computer-executable instructions and may be a real or a virtual processor. In a multi-processing system, multiple processing units execute computer-executable instructions to increase processing power. The memory 720 may be volatile memory (e.g., registers, cache, RAM), non-volatile memory (e.g., ROM, EEPROM, flash memory, etc.), or some combination of the two. In some embodiments, the memory 720 stores software 780 implementing described techniques.

A computing environment, such as watermark management computing device 600 which may comprise watermark embedding computing device 500 and/or watermark extracting computing device 600 may have additional types and/or numbers of features. For example, the watermark management computing device 700 may include storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The storage 740 may be removable or non-removable, and includes magnetic disks, magnetic tapes or cassettes, CD-ROMs, CD-RWs, DVDs, or any other medium which may be used to store information and which may be accessed within the computing environment 700. In some embodiments, the storage 740 stores instructions for the software 780.

The input device(s) 750 may be a touch input device such as a keyboard, mouse, pen, trackball, touch screen, or game controller, a voice input device, a scanning device, a digital camera, or another device that provides input to the watermark management computing device 700. The output device(s) 760 may be a display, printer, speaker, or another device that provides output from the watermark management computing device 700.

The communication connection(s) 770 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may also be described in the general context of non-transitory computer-readable media. Non-transitory computer-readable media are any available media that may be accessed within a computing environment. By way of example, and not limitation, within the watermark management computing device 700, non-transitory computer-readable media may by way of example only include memory 720, storage 740, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method for embedding a watermark in a text document, the method comprising:
receiving, by a watermark management computing device, a watermark and the text document comprising of one or more pages;
transforming, by the watermark management computing device, the one or more pages of the text document into one or more corresponding images;
detecting, by the watermark management computing device, one or more margins on each of the one or more images;
generating, by the watermark management computing device, one or more cropped images wherein the cropped images are generated by cropping the detected one or more margins from each of the one or more images;
segmenting, by the watermark management computing device, each of the one or more cropped images into a plurality of blocks;
selecting, by the watermark management computing device, one or more blocks from the plurality of blocks based on content of each of the plurality of blocks; and
embedding, by the watermark management computing device, the watermark in each of the selected one or more blocks using a watermarking process.

2. The method of claim 1, where in the method further comprising:
superimposing, by the watermark management computing device, the watermark embedded blocks onto the corresponding one or more images; and
converting, by the watermark management computing device, the one or more images into the corresponding one or more pages of the text document.

3. The method of claim 1, wherein detecting of the one or more margins comprises:
using, by the watermark management computing device, a discrete differentiation operator over the one or more images; and
computing, by the watermark management computing device, a distance of a first white pixel from one or more sides of the one or more images.

4. The method of claim 3, wherein generating the one or more cropped images from the corresponding one or more images comprises:
cropping, by the watermark management computing device, the one or more images from the sides based on the computed distance of the first white pixel from the one or more sides of the image.

5. The method of claim 1, wherein selecting one or more blocks from the plurality of blocks comprises:
applying, by the watermark management computing device, a discrete cosine transform (DCT) on each of the plurality of blocks to compute a DCT co-efficient of the one or more blocks;
classifying, by the watermark management computing device, the plurality of blocks into texture blocks or non-texture blocks using the DCT co-efficient of each of the one or more blocks; and
selecting, by the watermark management computing device, the texture blocks for embedding the watermark.

6. The method of claim 5, wherein classifying the plurality of blocks comprises:
comparing, by the watermark management computing device, the DCT co-efficient of each of the one or more block with a content thresholds of the block.

7. The method as claimed in claim 1, wherein the watermarking process is either an image or a video watermarking process.

8. A method for extracting a watermark from a watermarked text document, the method comprising:
receiving, by a watermark management computing device, the watermarked text document comprising of one or more pages and block information, wherein the block information comprises segmentation process details such as block size, a original cropped image size and a content thresholds;
converting, by the watermark management computing device, the one or more pages into corresponding one or more images;
detecting, by the watermark management computing device, one or more margins on each of the one or more images;
generating, by the watermark management computing device, one or more cropped images wherein the cropped images are generated by cropping the detected one or more margins from each of the one or more images;
resizing, by the watermark management computing device, the one or more cropped images based on the original cropped image size;
segmenting, by the watermark management computing device, each of the one or more resized cropped images into a plurality of blocks wherein the segmentation of the cropped images is based on the block size;
selecting, by the watermark management computing device, one or more blocks from the plurality of blocks based on the content thresholds; and
extracting, by the watermark management computing device, the watermark from each of the selected one or more blocks.

9. The method of claim 8, wherein detecting of the one or more margins comprises:
using, by the watermark management computing device, a discrete differentiation operator over the one or more images; and
computing, by the watermark management computing device, a distance of a first white pixel from one or more sides of the one or more images.

10. The method of claim 9, wherein generating the one or more cropped images from the corresponding one or more images comprises:
cropping, by the watermark management computing device, the one or more images from the sides based on the computed distance of the first white pixel from the one or more sides of the image.

11. The method of claim 8, wherein resizing of the one or more cropped images is based on interpolation process.

12. The method of claim 8, wherein selecting one or more blocks from the plurality of blocks comprises:
applying, by the watermark management computing device, a discrete cosine transform (DCT) on each of the plurality of blocks to compute a DCT co-efficient of the one or more blocks;
classifying, by the watermark management computing device, the plurality of blocks into texture blocks or non-texture blocks using the DCT co-efficient of each of the one or more blocks wherein the plurality of blocks are classified by comparing the DCT co-efficient of each of the one or more blocks with the content thresholds; and
selecting, by the watermark management computing device, the texture blocks for embedding the watermark.

13. A watermark management computing device comprising:
a processor; and
a memory coupled to the processor which is configured to be capable of executing programmed instructions comprising and stored in the memory to:
receive a watermark and the text document comprising of one or more pages;
transform the one or more pages of the text document into one or more corresponding images;
detect one or more margins on each of the one or more images;
generate one or more cropped images wherein the cropped images are generated by cropping the detected one or more margins from each of the one or more images;
segment each of the one or more cropped images into a plurality of blocks;
select one or more blocks from the plurality of blocks based on content of each of the plurality of blocks; and
embed the watermark in each of the selected one or more blocks using a watermarking process.

14. The watermark management computing device of claim 13, wherein the processor coupled to the memory is further configured to be capable of executing the programmed instructions further comprising and stored in the memory to:
superimpose the watermark embedded blocks onto the corresponding one or more images; and
convert the one or more images into the corresponding one or more pages of the text document.

15. The watermark management computing device of claim 13, wherein the processor coupled to the memory is further configured to be capable of executing the programmed instructions for the detecting further comprising and stored in the memory to:
use a discrete differentiation operator over the one or more images; and
compute a distance of a first white pixel from one or more sides of the one or more images.

16. The watermark management computing device of claim 15, wherein the processor coupled to the memory is further configured to be capable of executing the programmed instructions for the generating the one or more cropped images from the corresponding one or more images further comprising and stored in the memory to:
crop the one or more images from the sides based on the computed distance of the first white pixel from the one or more sides of the image.

17. The watermark management computing device of claim 13, wherein the processor coupled to the memory is further configured to be capable of executing the programmed instructions for the selecting one or more blocks from the plurality of blocks further comprising and stored in the memory to:
apply a discrete cosine transform (DCT) on each of the plurality of blocks to compute a DCT co-efficient of the one or more blocks;
classify the plurality of blocks into texture blocks or a non-texture blocks using the DCT co-efficient of each of the one or more blocks; and
select the texture blocks for embedding the watermark.

18. The watermark management computing device of claim 17, wherein the processor coupled to the memory is further configured to be capable of executing the programmed instructions for the classifying the plurality of blocks further comprising and stored in the memory to:
compare the DCT co-efficient of each of the one or more block with a content thresholds of the block.

19. The watermark management computing device of claim 13, wherein the watermarking process is either an image or video watermarking process.

20. A watermark management computing device comprising:
a processor; and
a memory coupled to the processor which is configured to be capable of executing programmed instructions comprising and stored in the memory to:
receive the watermarked text document comprising of one or more pages and block information, wherein the block information comprises segmentation process details such as block size, an original cropped image size and a content thresholds;
convert the one or more pages into corresponding one or more images;
detect one or more margins on each of the one or more images;
generate one or more cropped images wherein the cropped images are generated by cropping the detected one or more margins from each of the one or more images;
resize the one or more cropped images based on the original cropped image size;
segment each of the one or more resized cropped images into a plurality of blocks wherein the segmentation of the cropped images is based on the segmentation process details;
select one or more blocks from the plurality of blocks based on the content thresholds; and
extract the watermark from each of the selected one or more blocks.

21. The watermark management computing device of claim 20, wherein the processor coupled to the memory is further configured to be capable of executing the programmed instructions for the detecting of the one or more margins further comprising and stored in the memory to:
use a discrete differentiation operator over the one or more images; and
compute a distance of a first white pixel from one or more sides of the one or more images.

22. The watermark management computing device of claim 21, wherein the processor coupled to the memory is further configured to be capable of executing the programmed instructions for the generating the one or more cropped images from the corresponding one or more images further comprising and stored in the memory to:
crop the one or more images from the sides based on the computed distance of the first white pixel from the one or more sides of the image.

23. The watermark management computing device of claim 20, wherein resizing of the one or more cropped images is based on interpolation process.

24. The watermark management computing device of claim 20, wherein the processor coupled to the memory is further configured to be capable of executing the programmed instructions for the selecting one or more blocks from the plurality of blocks further comprising and stored in the memory to:
apply a discrete cosine transform (DCT) on each of the plurality of blocks to compute a DCT co-efficient of the one or more blocks;
classify the plurality of blocks into texture blocks or a non-texture blocks using the DCT co-efficient of each of the one or more blocks wherein the plurality of blocks are classified by comparing the DCT co-efficient of each of the one or more blocks with the content thresholds; and
select the texture blocks for embedding the watermark.

25. A non-transitory computer readable medium having stored thereon instructions for embedding a watermark in a text document which when executed by a processor, cause the processor to perform steps comprising:
receiving a watermark and the text document comprising of one or more pages;
transforming the one or more pages of the text document into one or more corresponding images;
detecting one or more margins on each of the one or more images;
generating one or more cropped images wherein the cropped images are generated by cropping the detected one or more margins from each of the one or more images;
segmenting each of the one or more cropped images into a plurality of blocks;
selecting one or more blocks from the plurality of blocks based on content of each of the plurality of blocks; and
embedding the watermark in each of the selected one or more blocks using a watermarking process.

26. A non-transitory computer readable medium having stored thereon instructions for extracting a watermark from a watermarked text document which when executed by a processor, cause the processor to perform steps comprising:
receiving a watermarked text document comprising of one or more pages and block information, wherein the block information comprises segmentation process details such as block size, an original cropped image size and a content thresholds;
converting the one or more pages into corresponding one or more images;
detecting one or more margins on each of the one or more images;
generating one or more cropped images wherein the cropped images are generated by cropping the detected one or more margins from each of the one or more images;
resizing the one or more cropped images based on the original cropped image size;
segmenting each of the one or more resized cropped images into a plurality of blocks wherein the segmentation of the cropped images is based on the block size;
selecting one or more blocks from the plurality of blocks based on the content thresholds; and
extracting the watermark from each of the selected one or more blocks.
